(19) United States
(12) Patent Application Publication
(10) Pub. No.: US 2011/0241254 A1
(43) Pub. Date: Oct. 6, 2011

(54) THERMOPLASTIC RESIN-BASED COMPOSITION FOR MAKING SINGLE-LAYER SKINS OR COMPOSITES WITH SPECKLED APPEARANCE FOR PARTS OF MOTOR VEHICLE PASSENGER COMPARTMENT AND METHOD FOR OBTAINING SAME

(75) Inventors: Ludovic Hardouin-Duparc, Reims (FR); Jean-Francois Vautrin, Reims (FR)

(73) Assignee: Arkema France, Colombes (FR)

(21) Appl. No.: 12/281,203

(22) PCT Filed: Mar. 7, 2007
(86) PCT No.: PCT/FR2007/050890

§ 371 Date: Nov. 19, 2010

(30) Foreign Application Priority Data
Mar. 8, 2006 (FR) 0602055

(51) Int. Cl. B32B 27/20; C08L 27/06; B32B 27/30; B29C 41/42

(52) U.S. Cl. 264/334; 524/527; 428/323; 428/463; 428/442; 428/520; 428/325; 428/327

(57) ABSTRACT

The invention concerns a thermoplastic resin-based composition, for making single-layer or multilayer skins (or composite structures), having a speckled appearance, and a method for obtaining same. Said composition comprises: 10 to 99 wt. % of a compound or “matrix” of a polyvinyl chloride thermoplastic (PVC) resin; 0.5 to 90 wt. % of at least a compound or “inclusion” of a thermoplastic resin containing at least one colouring pigment: 0.5 to 20 wt. % of speckling agents selected among colouring pigments, metal particles or decorative flakes, glass beads, polymeric particles.

The present invention relates to compositions based on thermoplastic resins that make it possible to produce monolayer or multilayer “skins” (called composite structures) having a flecked appearance, of the matrix/inclusions type.

The multilayer skins or composite structures comprise one outer layer which may be produced according to the invention and at least one inner layer which may also be produced according to the invention or according to a conventional method; these skins comprise a matrix and inclusions; these monolayer or multilayer skins are used for parts of the passenger compartment of motor vehicles, such as, in particular, dashboards equipped with visible airbags (having separate covers) or integrated airbags (also called invisible airbags, i.e. not visible to the driver and the passengers), central consoles and door linings or panels.

Another subject of the invention is the method for manufacturing these compositions, especially in the form of powders obtained by blending.

Prior Art:

In the technical field of manufacturing automotive vehicle instrument panels it is known to use skins of those panels produced conventionally, especially by the moulding technique in which powder is poured into a hot mould, either by rotomoulding or by slush moulding.

These instrument panels comprise, in general, an external imitation leather “skin” that gives the external appearance (in particular the colour, pattern and feel). Conventionally, the main materials used are thermoplastic resins such as polyvinyl chloride (PVC) thermoplastic polyurethanes (TPUs), and thermoplastic polyolefins (TPOs). A foam-based material, in general made from expanded polyurethane or PVC, is used as a backing to provide the properties of flexibility and thermal and sound insulation.

The outer skin is subjected to external attack: scratches, UV radiation, temperature, solvents, etc. In certain cases, the “skin” may be produced so as to provide particular appearance properties, in particular: decoration, colour, feel or ageing or abrasion resistance. Moreover, the monolayer or multilayer skins must meet the specifications of the automotive vehicle manufacturers, in particular the demands as regards the opening of an integrated or non-integrated airbag, that is to say opening in a very short lapse of time without spraying particles, for temperatures conventionally between −40° C. and +80° C.

There are several technologies for producing composite skins having a modified surface, obtained by applying at least one coating layer onto the surface of a mould, in a step prior to manufacturing a skin.

In particular, the method known as “in-mould painting” (IMP), as described in patent EP 0 912 312 by the Applicant, comprises the following steps:

1) depositing on the surface of a mould a composition A comprising at least one plasticizer and optionally one or more modifying agents, especially chosen from coloration pigments or decorative flakes;

2) then depositing, on the mould that has been completely or partially coated in 1), a composition B comprising a thermoplastic resin; and

3) gradual heating of the mould to enable the absorption of the composition A by the layer of the composition B, then rapid heating until the thermoplastic resin gels.

However, such a method makes it impossible to obtain satisfactory colour heterogeneity, called a flecked (or marbled, or speckled) appearance, on the surface of the skin obtained.

The Applicant has developed a novel composition based on thermoplastic resins for producing, especially by slush moulding, a monolayer or multilayer coloured skin with a controlled flecked appearance, and also its production method.

According to a first subject, the invention relates to a composition based on thermoplastic resins, with a flecked appearance, comprising:

from 10 to 99% by weight of a compound, known as “matrix” compound, of a polyvinyl chloride (PVC) thermoplastic resin;

from 0.5 to 90% by weight of at least one compound, known as “inclusion” compound, of a thermoplastic resin incorporating at least one colorant pigment; and

from 0.5 to 20% by weight of flecking agents chosen from coloration pigments, metal particles or decorative flakes, glass beads or polymer particles.

According to a second subject, the invention relates to a method for obtaining a composition with a flecked appearance comprising the following steps:

a first step of producing a compound based on PVC resin called a “matrix”;

a second step of producing one or more compounds based on a PVC resin known as an “inclusion”, by mixing at least one colorant pigment with the PVC resin; and

a step referred to as “flecking” (or “speckling”) that consists in mixing, at a suitable level, the “matrix” compound(s) with the “inclusion” compound(s) and with one or more flecking agents chosen from pigments, metal particles, glass beads or polymer particles.

According to a third subject, the invention relates to a composition obtained by the preceding method.

According to a fourth subject, the invention also relates to the use of the composition described above for manufacturing one layer of a monolayer or multilayer skin with a flecked appearance for the parts of the passenger compartment of motor vehicles.

According to a fifth subject, the invention relates to a method for producing a skin layer for a dashboard, comprising:

depositing the composition defined previously onto the surface of a shaped mould; and

melting this composition placed in the mould so that it is converted into a flexible object that is removed from the mould.

The Composition According to the invention:

The invention relates to a composition based on thermoplastic resins for producing, especially by slush moulding, one layer of a monolayer or multilayer skin, with a flecked effect, characterized in that it comprises:

from 10 to 99% by weight of a compound, known as “matrix” compound of a polyvinyl chloride (PVC) thermoplastic resin;

from 0.5 to 90% by weight of at least one compound, known as “inclusion” compound of a thermoplastic resin incorporating at least one colorant pigment; and

from 0.5 to 20% by weight of flecking agents chosen from coloration pigments, metal particles or decorative flakes, glass beads or polymer particles.

The percentage of inclusion compounds and flecking agents may, for example, be within the range going from 1 to 50% by weight of the composition.

### The “Matrix” Compound:

According to the invention, the compound known as a “matrix” essentially comprises a thermoplastic resin chosen from polyvinyl chloride (PVC) or a blend of PVC with a compatible polymer chosen from copolymers or terpolymers of vinyl chloride and vinyl acetate (VC/VA) or vinyl chloride and acrylic derivative (VC/AD), thermoplastic polyurethanes (TPUs), thermoplastic polyetheresters, ethylene/vinyl monomer (EVA) copolymers, ethylene/vinyl monomer/carbonyl terpolymers, melt-processable acrylic elastomers, copolymers having polyamide blocks and polyether blocks or polyether block amides, chlorinated or chlorosulphonated polyethylenes, functionalized or unfunctionalized ethylene/alkyl(meth)acrylate or (meth)acrylic acid polymers, MBS core-shell polymers, SBM block terpolymers, PVDF and powdered polyamide resins.

According to one preferred embodiment of the invention, the thermoplastic resin used is a polyvinyl chloride (PVC) with a K-value between 50 and 80.

According to one embodiment, the thermoplastic resin is polyvinyl chloride (PVC) obtained by a suspension or microsuspension process, but PVC manufactured in emulsion or in bulk may also be used.

An example of a VC/VA copolymer is LACOVYL® from Arkema, an example of a VC/AD copolymer is VINNOLIT® from Vinnolit, an example of a TPU is ESTANE® from Goodrich, an example of a thermoplastic polyetherester is HYTREL® from DuPont, an example of a polyether-block-amide is PEBAX® from Arkema, an example of an EVA is EVATANE from Arkema, an example of an ethylene/vinylmonomer/carbonyl terpolymer is ELVALOY® from DuPont, examples of functionalized or unfunctionalized ethylene/alkyl(meth)acrylate or (meth)acrylic acid polymers are LOTRYL®, LOTADER® and OREVAC® from Arkema, an example of chlorinated or chlorosulphonated polyethylenes is TYRIN® from DuPont, an example of a melt-processable acrylic elastomer is ALCRYN® from Apa, an example of powdered polyamide resins is ORGASOL® from Arkema. These polymers that are compatible with PVC, said to be “alloyed” with the PVC, have good low-temperature properties and are capable of conferring a suitable brittleness to the layers incorporating them.

According to the invention, suitable blends of thermoplastic resins comprising PVC resins and copolymers or terpolymers of vinyl chloride and vinyl acetate (VC/VA) or vinyl chloride and an acrylic derivative (VC/AD), and also PVC resins and thermoplastic polyurethanes (TPUs). These various resins may be blended together in large amounts.

The “matrix” compound may comprise, in addition, at least one additive chosen from plasticizers, heat stabilizers or UV stabilizers, antioxidants, processing aids, lubricants, fillers, and coloration pigments, hereinafter referred to as matrix pigments.

According to one embodiment, the plasticizer or plasticizers used are of monomeric and/or polymeric nature, and is (are) chosen, in particular, from azelates, trimellitates, sebacates, adipates, polyadipates, phthalates, polyphthalates, citrates, benzoates, tallates, glutarates, fumarates, maleates, oleates, palmitates and acetates.

The “matrix” compound according to the invention also relates to blends of polymeric plasticizer(s) and monomeric plasticizer(s), as described above, in very large amounts.

According to one embodiment, the weight ratio of the plasticizers to the resin is at least 60/100.

As the heat stabilizer, mention may be made, by way of example, of metal salts, especially those of calcium, zinc and tin; and complexes based on aluminium, potassium or sodium.

The UV stabilizers may be chosen from benzotriazoles and cyanoacrylates.

The coloration pigments used may either be organic or mineral. Mention may be made, by way of example, of titanium dioxide, the chromophtal red BRN pigment from Ciba, the blue GLSM pigment, of IRGALITE yellow in BRM and orange thiosol GL.

According to one preferential embodiment, the coloration pigments, the fillers, the lubricants, the UV stabilizers, the heat stabilizers, the processing aids and the antioxidants are at levels preferably between 3 and 10% by weight relative to the thermoplastic resin.

### The “Inclusion” Compound:

According to the invention, the “inclusion” compound comprises at least:

a thermoplastic resin chosen from polyvinyl chloride (PVC) or a blend of PVC with a compatible polymer chosen from copolymers or terpolymers of vinyl chloride and vinyl acetate (VC/VA) or vinyl chloride and acrylic derivative (VC/AD), thermoplastic polyurethanes (TPUs), thermoplastic polyetheresters, ethylene/vinyl monomer (EVA) copolymers, ethylene/vinyl monomer/carbonyl terpolymers, melt-processable acrylic elastomers, copolymers having polyamide blocks and polyether blocks or polyether block amides, chlorinated or chlorosulphonated polyethylenes, functionalized or unfunctionalized ethylene/alkyl(meth)acrylate or (meth)acrylic acid polymers, MBS core-shell polymers, SBM block terpolymers, PVDF and powdered polyamide resins; and

at least one colouration pigment, called an inclusion pigment, of a different colour to the matrix pigments optionally present in the “matrix” compound.

The thermoplastic resin of the “inclusion” compound may be of an identical nature to or of a different nature from the “matrix” compound.

The “inclusion” compound may comprise, in addition, at least one additive chosen from plasticizers, heat stabilizers or UV stabilizers, antioxidants, processing aids, lubricants or fillers.

### The Flecking Agents:

The flecking (or marbling) agents according to the invention are chosen in order to obtain special effects in the finished product, such as pearly, metallized, phosphorescent, fluorescent, thermochromic, interference and granite effects or a special feel, such as a soft feel. They have a size lying in the range going from 40 to 200 μm, and more preferentially in the range going from 50 to 120 μm. They are chosen from coloration pigments, metal particles or decorative flakes, glass beads or polymer particles.

Another subject of the invention is the method for preparing the composition according to the invention in order to obtain a composition in powder form (especially a compound made of plasticized PVC) that can especially be converted by the conventional slush-moulding techniques in order to produce “skins” intended for the parts of the passenger compartment of motor vehicles

### The Method According to the Invention for Preparing the Above Composition:

The method according to the invention for obtaining a composition having a flecked appearance comprises the following steps:

a first step of producing a compound based on PVC resin, called “matrix” compound, as defined previously;

a second step of producing one or more compounds based on a PVC resin known as an “inclusion”, as defined previously by mixing at least one colorant pigment with the PVC resin; and

a step referred to as “flecking” (or “marbling” or “speckling”) that consists in mixing, at a suitable level, the “matrix” compound(s) with the “inclusion” compound(s) and with one or more flecking agents chosen from coloration pigments, metal particles, glass beads or polymer particles, preferentially with a density equivalent to that of the material forming the matrix.

The various steps are carried out using suitable equipment, according to a specific and conventional mixing method and with the suitable implementation parameters. The production of “matrix” and “inclusion” compounds is well known to a person skilled in the art. These “matrix” and “inclusion” compounds are in the form of powders having a well-defined density (on average, the density of a PVC resin compound is 1.20 g/cm³), having an average particle size between 100 and 200 μm and having a pourability suitable for the slush-moulding process, used to obtain skins.

The flecking agents and the inclusion compound(s) preferentially have a density equivalent to the matrix compound.

The percentage of inclusion compounds and flecking agents may, for example, be within the range going from 1 to 50% by weight of the composition, depending on the desired effect.

Another subject of the present invention is the use of the composition according to the invention, to obtain a skin or composite structure layer for the parts of the passenger compartment of motor vehicles, such as dashboards, central consoles and door linings or panels.

One subject of the present invention is a method for producing one layer of a monolayer or multilayer (composite structure) skin, especially for a dashboard, comprising the deposition of the composition defined above onto the surface of a shaped mould and, the melting of this composition placed in the mould so that it is converted into a flexible object that is removed from the mould. This composition may be deposited onto the mould using the usual moulding techniques such as rotomoulding and slush moulding. According to one preferred embodiment of the invention, the method used is slush moulding.

The skin layers or composite structure obtained according to the invention have an attractive flecked appearance. They have a controlled heterogeneity of colour and appearance. The following examples illustrate the invention without however limiting the scope thereof.

### EXAMPLES

1) Example 1 for producing a flecked composition coloured with glass beads according to the invention:

An industrial sample of around 200 kg of powder was prepared for slush moulding in a shade defined and named “Speckled Bordeaux”. This shade consists of a Bordeaux-coloured PVC matrix, flecked (or marbled or speckled) with a beige-coloured PVC powder.

Step 1: production of the Bordeaux- coloured PVC matrix powder (“matrix” compound) for slush moulding according to the conventional compounding method.

Percentages of the various components expressed by weight:

PVC resin: 50;

plasticizers (especially including trioctyl trimellitates (TOTM)): 40; and

additives including coloration pigments: 10 (6 different pigments used).

Testing the main properties of the powder gave the following results:

bulk density: around 650 g/l; colour: characterized on one of the existing scales, such as for example the CIELab scale; pourability: around 40 s according to the ISO 6186 Standard, Method A, Opening 10 mm;

thermal stability: Congo Red at 220° C. of around 50 minutes; and

particle size: Gaussian distribution of the average particle size around 170 μm.

Step 2: Production of the beige-coloured PVC inclusion powder (“inclusion” compound) for slush moulding according to the conventional compounding method.

The weight percentages of the various components were identical to those of Step 1, only the nature and the amount of the coloration pigments changes. Testing the main properties of the powder gave approximately the same values as for Step 1, except for the colour.

Step 3: flecking of the Bordeaux powder with an amount between 5 and 7 phr (parts per hundred of resin), namely 7% of the composition, of beige powder and 2.5 phr of glass beads having a diameter between 90 and 100 microns, sold by Sovitec under the reference AG 215 in order to achieve the effect defined by the client. Testing the pourability of the powder gave a value of 40 seconds and a visual evaluation of the effect obtained was carried out.

The illustrations of the powders and skins obtained are represented in the following figures:

FIG. 1 shows the appearance of the powder obtained after mixing and before the slush-moulding treatment.

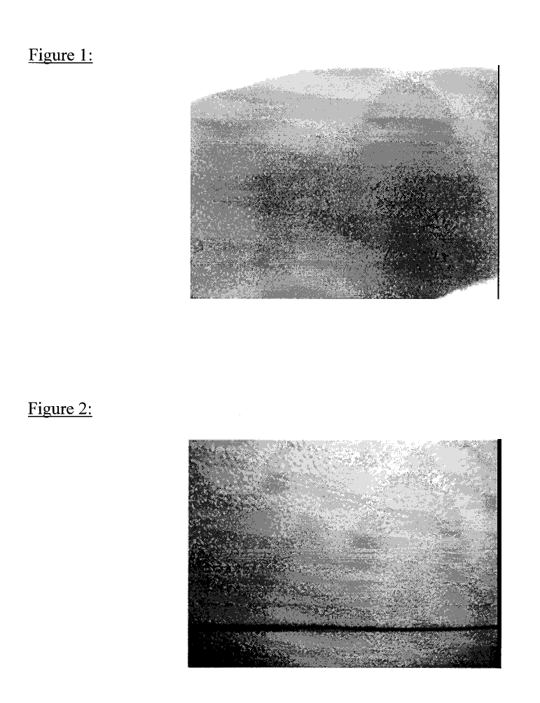

FIG. 2 shows the flecked appearance of the skin obtained after the slush-moulding treatment of the powder in a mould.

The differences in colour are due, in particular, to the grain on the surface of the mould and to the slush moulding process, in particular the heating of the mould.

2) Example 2 for producing a coloured flecked composition with coloration pigments according to the invention:

New samples were prepared by following the same method as for Example 1, with the following differences in the mixing steps:

A: 100 phr of white PVC matrix powder (pigment used: TiO₂);

B: 66.7 phr of beige PVC inclusion powder (4 different pigments used);

C: 28.6 phr of light grey PVC inclusion powder (4 different pigments used); and

D: 3.7 phr of black coloration pigments.

Each of the powders A, B and C have a composition similar to that of the powders from Example 1. Successive mixing was carried out with the white powder (“matrix” compound) forming the matrix, with the various beige and grey inclusion powders (“inclusion” compound) and with the black colouring pigment (flecking agent).

The colouring and flecking results of the skin obtained by slush moulding of the final powder above can be seen in the photograph of FIG. 3; two distinct zones with different appearances (smoother on the right) can be seen, separated by a central vertical line, which corresponds to a surface finish (graining) that is different from the surface of the mould used to obtain the skin.

3) Example 3 for producing a metallized flecked composition according to the invention:

New samples were prepared by following the same method as for Example 1, with the following differences in the mixing steps:

A: 33 phr of indigo blue PVC matrix powder (5 different pigments used);

B: 33 phr of Bordeaux PVC inclusion powder;

C: 33 phr of light grey PVC inclusion powder; and

D: 2.5 phr of a metal pigment (metal particles) sold under the reference Magna Pearl 5000.

Each of the powders A, B and C had a composition similar to that of the powders from Example 1. Successive mixing was carried out with the blue powder (“matrix” compound) forming the matrix, with various Bordeaux and grey inclusion powders (“inclusion” compound) and metal particles (flecking agents).

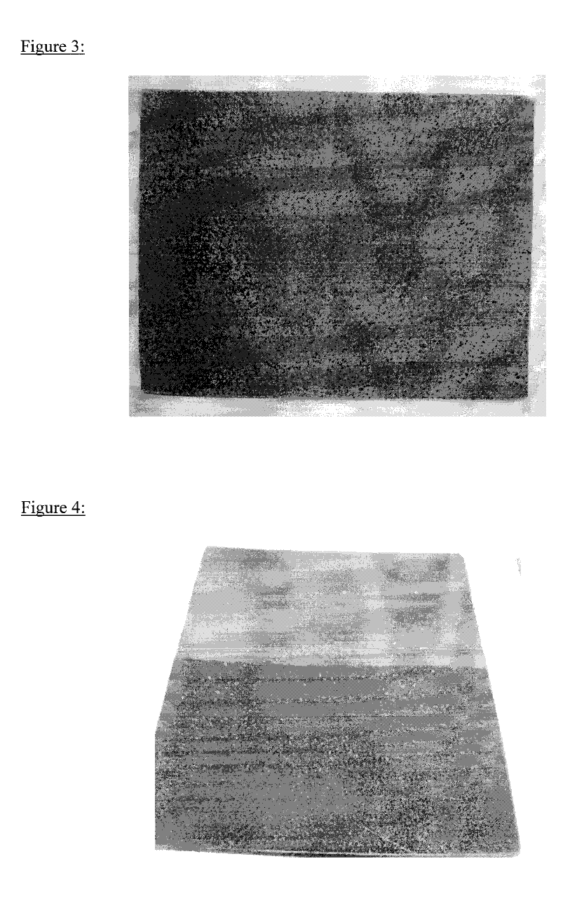

The colouring results and the flecked appearance of the skin obtained from the powder, by slush moulding, are visible in the photograph of FIG. 4.

1. Method for obtaining a composition with a flecked appearance comprising the following steps:
producing a matrix compound based on polyvinyl chloride (PVC) resin;
forming one or more inclusion compounds based on a PVC resin by mixing at least one colorant pigment with said PVC resin; and
mixing, at a suitable level, the “matrix” compound(s) with the “inclusion” compound(s) and with one or more flecking agents chosen from pigments, metal particles, glass beads or polymer particles, to produce a flecked appearance.

2. Method according to claim 1, wherein said composition comprises:
from 10 to 99% by weight of a matrix compound of a polyvinyl chloride (PVC) thermoplastic resin;
from 0.5 to 90% by weight of at least one inclusion compound of a thermoplastic resin incorporating at least one colorant pigment; and
from 0.5 to 20% by weight of one or more flecking agents chosen from coloration pigments, metal particles or decorative flakes, glass beads or polymer particles.

3. Method according to claim 1, wherein the percentage of inclusion compounds and flecking agents ranges from 1 to 50% by weight of the composition.

4. Method according to claim 2, wherein the thermoplastic resin of the matrix compound and/or of the inclusion compound is polyvinyl chloride with a K-value between 50 and 80.

5. Method according to claim 1, wherein the thermoplastic resin of the matrix compound and/or of the inclusion compound comprises a blend of polyvinyl chloride (PVC) with a compatible polymer chosen from copolymers or terpolymers of vinyl chloride and vinyl acetate (VC/VA) or vinyl chloride and acrylic derivative (VC/AD), thermoplastic polyurethanes (TPUs), thermoplastic polyetheresters, ethylene/vinyl monomer (EVA) copolymers, ethylene/vinyl monomer/carbonyl terpolymers, melt-processable acrylic elastomers, copolymers having polyamide blocks and polyether blocks or polyether block amides, chlorinated or chlorosulphonated polyethylenes, functionalized or unfunctionalized ethylene/alkyl(meth)acrylate or (meth)acrylic acid polymers, methylmethacrylate-butadiene-styrene (MBS) core-shell polymyers; styrene, butadiene, methacrylate (SBM) block terpolymers, polyvinylidene fluoride (PVDF) and powdered polyamide resins.

6. Method according to claim 1, wherein the flecking agents have a size of from 50 to 120 μm.

7. (canceled)

8. Composition comprising:
from 10 to 99% by weight of a matrix compound of a polyvinyl chloride (PVC) thermoplastic resin;
from 0.5 to 90% by weight of at least one inclusion compound of a thermoplastic resin incorporating at least one colorant pigment; and
from 0.5 to 20% by weight of one or more flecking agents chosen from coloration pigments, metal particles or decorative flakes, glass beads or polymer particles,
wherein said composition is a monolayer or multilayer skin having a flecked appearance.

9. Composition according to claim 8, wherein the thermoplastic resin of the matrix compound and/or of the inclusion compound is polyvinyl chloride with a K-value between 50 and 80.

10. Composition according to claim 8, wherein the thermoplastic resin of the matrix compound and/or of the inclusion compound comprises a blend of polyvinyl chloride (PVC) with a compatible polymer chosen from copolymers or terpolymers of vinyl chloride and vinyl acetate (VC/VA) or vinyl chloride and acrylic derivative (VC/AD), thermoplastic polyurethanes (TPUs), thermoplastic polyetheresters, ethylene/vinyl monomer (EVA) copolymers, ethylene/vinyl monomer/carbonyl terpolymers, melt-processable acrylic elastomers, copolymers having polyamide blocks and polyether blocks or polyether block amides, chlorinated or chlorosulphonated polyethylenes, functionalized or unfunctionalized ethylene/alkyl(meth)acrylate or (meth)acrylic acid polymers, methylmethacrylate-butadiene-styrene (MBS) core-shell polymers styrene, butadiene, methacrylate (SBM) block terpolymers, polyvinylidene fluoride (PVDF) and powdered polyamide resins.

11. Composition according to claim 8, wherein the flecking agents have a size of from 50 to 120 μm.

12. Composition according to claim 8, comprising parts of the passenger compartment of motor vehicles. or panels.

13. Method for producing a skin layer for a dashboard, comprising:
depositing the composition according to claim 8 on to the surface of a shaped mould; and
melting this composition placed in the mould so that it is converted into a flexible object that is removed from the mould.

14. Composition of claim 12, wherein said parts comprise dashboards, central consoles and door linings or panels.
